(19) United States
(12) Patent Application Publication
(10) Pub. No.: US 2024/0288390 A1
(43) Pub. Date: Aug. 29, 2024

(54) METHOD FOR ANALYZING SOLID ELECTROLYTE FILM STRUCTURE

(71) Applicants: LG ENERGY SOLUTION, LTD., Seoul (KR); THE REGENTS OF THE UNIVERSITY OF CALIFORNIA, Oakland, CA (US)

(72) Inventors: Jung Pil LEE, Daejeon (KR); Min Sang SONG, Daejeon (KR); Dong Ju LEE, La Jolla, CA (US); Zheng CHEN, San Diego, CA (US)

(21) Appl. No.: 18/584,514

(22) Filed: Feb. 22, 2024

(30) Foreign Application Priority Data
Feb. 23, 2023 (KR) 10-2023-0024417

(51) Int. Cl. G01N 23/2251; G01N 1/28

(52) U.S. Cl. CPC G01N 23/2251; G01N 1/28

(57) ABSTRACT

A method for analyzing a structure of a solid electrolyte film, including a step of: immersing the solid electrolyte film including a solid electrolyte and a binder into a polar solvent to remove the solid electrolyte from the solid electrolyte film; and analyzing a structure of the solid electrolyte film in which the solid electrolyte is removed.

### CROSS-REFERENCE TO RELATED APPLICATIONS

This application claims the benefit of and priority to Korean Patent Application No. 10-2023-0024417, filed Feb. 23, 2023, the disclosure of which is incorporated herein by reference in its entirety.

### TECHNICAL FIELD

The present disclosure relates to a method for analyzing the structure of a solid electrolyte film.

### BACKGROUND

There continues to be an increase in electrified transportation, exemplified by the widespread adoption of electric vehicles (EVs) and the emergence of urban air mobility (UAM) vehicles. Simultaneously, there is a growing demand for stationary energy storage systems, notably in the residential and industrial sectors, powered by solar and wind generators. This shift is driven in part by the pressing need to mitigate the adverse environmental and climate impacts associated with traditional internal combustion engines and other non-renewable means of power generation. Thus, the development of battery technologies with high energy density, while also ensuring enhanced safety, has become an imperative.

From the viewpoint of limitations with respect to capacity, safety, output, large size, miniaturization, etc., of batteries, various batteries that can overcome the limitations of lithium secondary batteries are currently being studied.

On-going studies are being concentrated on different types of batteries. These include metal-air batteries that have large theoretical capacities and all-solid-state batteries that do not have explosion hazards in terms of safety. Also, there are supercapacitors in terms of output, NaS batteries or redox flow batteries (RFB) in terms of large size, and thin film batteries in terms of miniaturization.

The solid-state battery refers to a battery in which a part or all of the liquid electrolyte used in the existing lithium secondary battery is replaced with a solid electrolyte. Such solid-state batteries are safer since they do not use a flammable solvent, so there is no ignition or explosion likelihood caused by the decomposition reactions of a conventional electrolyte solution. In addition, in the case of the solid-state battery, since Li metal or Li alloy may be used as a material for the negative electrode, there may be an advantage that the energy density of the battery may be remarkably improved.

In particular, among the solid electrolytes in solid-state batteries, mineral-based solid electrolytes can be categorized into sulfide-based and oxide-based solid electrolytes. Currently, the most technologically advanced solid electrolyte is the sulfide-based solid electrolyte, and the ionic conductivity of the solid electrolyte has been developed to the point where materials with ionic conductivity close to that of organic electrolytes are developed.

In recent years, research has been conducted on techniques to analyze the internal structure of solid electrolytes in order to improve the ionic conductivity of solid electrolytes. However, as the conventional solid electrolytes have low content of the binder, it is difficult to analyze their structures. Even if the structures of solid electrolyte is to be analyzed, the cross-section observed through Scanning Electron Microscope (SEM) images is two-dimensional (2D), which makes it difficult to analyze the three-dimensional structures.

Methods for analyzing sulfide-based solid electrolytes using computational modeling have been developed. However, computational simulation indirectly generates the three-dimensional structure of the sulfide-based solid electrolyte based on the conduction properties of lithium ions, so that only the structure of the sulfide-based solid electrolyte is predicted, and the accuracy of the structure analysis of the binder or pores inside the solid electrolyte film is somewhat reduced.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

The present inventors have completed the present disclosure after researching a method for efficiently removing only the solid electrolyte within the solid electrolyte film structure to accurately analyze the solid electrolyte film structure comprising a frame comprising a binder while keeping the solid electrolyte film structure intact.

The present disclosure seeks to provide a solid electrolyte film structure analysis method for a solid electrolyte film in which only the solid electrolyte in the solid electrolyte film structure can be efficiently removed, leaving the structure of the film intact, to analyze the structure of the solid electrolyte film, more specifically, the structure of the binder.

According to a first aspect of the present disclosure, the present disclosure provides a method for analyzing a solid electrolyte film structure, comprising the step of: immersing a solid electrolyte film comprising a solid electrolyte and a binder into a polar solvent to remove the solid electrolyte from the solid electrolyte film; and analyzing a structure of the solid electrolyte film in which the solid electrolyte is removed.

In an embodiment of the present disclosure, the polar solvent may comprise at least one of water or alcohol.

In an embodiment of the present disclosure, the alcohol may be an alcohol with a carbon number of 4 or less

In an embodiment of the present disclosure, the alcohol may be ethanol.

In an embodiment of the present disclosure, the solid electrolyte may comprise at least one of a sulfide-based solid electrolyte, a halide-based solid electrolyte or an oxide-based solid electrolyte.

In an embodiment of the present disclosure, the sulfide-based solid electrolyte may be represented by Formula 1:

Lₐ₁M_{b1}P_{c1}S_{d1}Aₑ₁ <Formula 1>

wherein in Formula 1, L is an element selected from Li, Na, and K; M is an element selected from B, Zn, Sn, Si, Cu, Ga, Sb, Al, and Ge; A is an element selected from I, Br, Cl, and F; each of a1, b1, c1, d1 and e1 represents a compositional ratio of each element; and a ratio of a1:b1:c1:d1:e1 is 1 to 12:0 to 1:1:2 to 12:0 to 5.

In an embodiment of the present disclosure, the sulfide-based solid electrolyte may be LPS-type sulfide containing sulfur and phosphorus, LPSCl-type sulfide, Li₄₋ₓGe₁₋ₓPₓS₄ (x is from 0.1 to 2), Li_{10±1}MP₂X₁₂ (M=Ge, Si, Sn or Al, and X=S or Se), Li_{3.833}Sn_{0.833}As_{0.166}S₄, Li₄SnS₄, Li_{3.25}Ge_{0.25}P_{0.75}S₄, Li₂S—P₂S₅, B₂S₃—Li₂S, xLi₂S-(100-x)P₂S₅ (x is from 70 to 80), Li₂S—LiI—P₂S₅, Li₂S—LiI—Li₂O—P₂S₅, Li₂S—LiBr—P₂S₅, Li₂S—LiCl—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₂S—SiS₂—Li₃N, Li₂S—SiS₂—LiI, or Li₂S—B₂S₃—LiI.

In an embodiment of the present disclosure, the halide-based solid electrolyte may be represented by Formula 2:

Li₆₋₃ₐMₐBr_{b}Cl_{c} <Formula 2>

wherein in Formula 2, M is a metal other than Li, a is 0<a<2, b is 0≤b≤6, c is 0≤c≤6, and b+c=6.

In an embodiment of the present disclosure, the oxide-based solid electrolyte may be represented by Formula 3:

Li_{1+x+y}AlₓTi₂₋ₓSi_{y}P_{3-y}O₁₂ <Formula 3>

wherein in Formula 3, x is 0≤x≤2 and y is 0≤y≤3.

In an embodiment of the present disclosure, the oxide-based solid electrolyte may be LLT-based solid electrolyte with a perovskite structure, LISICON, LATP-based solid electrolyte, LAGP-based solid electrolyte, or phosphate-based solid electrolyte.

In an embodiment of the present disclosure, the binder may comprise a fibrous binder and/or a particulate binder.

In an embodiment of the present disclosure, the binder may comprise at least one selected from a group including polytetrafluoroethylene (PTFE), ethylene-vinyl acetate (EVA), styrene-ethylene-butylene-styrene (SEBS), styrene butadiene rubber (SBR), nitrile butadiene rubber (NBR) and hydrogenated nitrile butadiene rubber (HNBR).

In an embodiment of the present disclosure, the polar solvent in the immersion step may be supplied to achieve a concentration of the solid electrolyte to 10 weight % or less.

In an embodiment of the present disclosure, the immersion step may be performed for a period of 5 minutes to 1 hour.

In an embodiment of the present disclosure, the immersion step may be performed for a period of 10 minutes to 1 hour.

In an embodiment of the present disclosure, the analyzing step may comprise analyzing a frame formed by the binder after removal of the solid electrolyte from the solid electrolyte film comprising the solid electrolyte and the binder.

In an embodiment of the present disclosure, the polar solvent may selectively dissolve only the solid electrolyte, but not the binder.

In an embodiment of the present disclosure, the analyzing step may be performed utilizing a Scanning Electron Microscope (SEM) image of the solid electrolyte film in which the solid electrolyte is removed.

In an embodiment of the present disclosure, the solid electrolyte film may be fabricated by a dry process.

In an embodiment of the present disclosure, the binder may comprise at least one of ethylene-vinyl acetate (EVA) or styrene-ethylene-butylene-styrene (SEBS), and the polar solvent may comprise at least one of water or ethanol. A method for analyzing the structure of a solid electrolyte film according to an embodiment of the present disclosure, by dissolving the solid electrolyte in a solid electrolyte film comprising a solid electrolyte and a binder using a polar solvent that selectively dissolves only the solid electrolyte, effectively removing the solid electrolyte from the solid electrolyte film while leaving the structure of the solid electrolyte film intact by the residual binder.

As the solid electrolyte is removed from within the solid electrolyte film, the internal structure, such as the connectivity of the binders that comprise the solid electrolyte film, can be readily seen.

### BRIEF DESCRIPTION OF DRAWINGS

FIG. 1 is a schematic diagram illustrating an analysis process of a solid electrolyte film structure, according to an embodiment of the present disclosure.

FIG. 2 is a photograph illustrating the analysis process of a solid electrolyte film structure, according to an embodiment of the present disclosure.

FIGS. 3A, 3B, 3C, 3D, 3E, 3F, 3G, 3H and 3I are scanning electron microscope (SEM) images of a solid electrolyte film obtained from Examples 1-3, and 5-8 and Comparative Examples 1 and 2.

### DETAILED DESCRIPTION

The embodiments provided by the present disclosure can be achieved by the following description. It should be understood that the following description describes exemplary embodiments of the present disclosure and these embodiments are not intended to limit the scope of the invention.

For any property described in this specification, if the measurement conditions and methods are not specifically stated, the property shall be measured in accordance with the measurement conditions and methods commonly used by one of ordinary skill in the art.

As used in this specification, the term “structural analysis of a solid electrolyte film” may refer to analyzing the structure of the binder, i.e., the frame formed by the binder after removal of the solid electrolyte from a solid electrolyte film comprising the solid electrolyte and the binder. The solid electrolyte film may be fabricated by a wet process or a dry process. The wet process uses a solvent, so there may be some residual solvent in the solid electrolyte film, but the residual amount is negligible, and the dry process does not use a solvent, so the solid electrolyte film consists only of the solid electrolyte and the binder, so removing the solid electrolyte from the solid electrolyte film may mean analyzing the structure of the binder.

### Methods for Analyzing Solid Electrolyte Film Structure

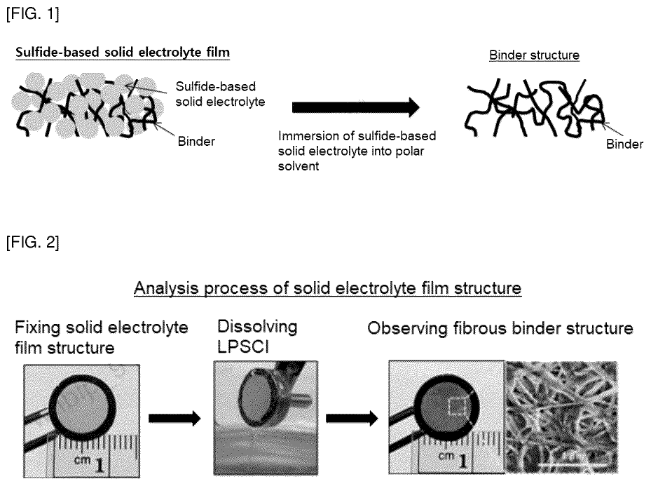

FIG. 1 is a schematic diagram illustrating a method for analyzing a solid electrolyte film structure, according to an embodiment of the present disclosure.

Referring to FIG. 1, the present disclosure relates to a method for analyzing a solid electrolyte film structure, which may include the step of immersing a solid electrolyte film comprising a solid electrolyte and a binder into a polar solvent to remove the solid electrolyte from the solid electrolyte film. After removing the solid electrolyte from the solid electrolyte film, a framework comprising the binder can be obtained, which can be used to analyze the solid electrolyte film structure. In FIG. 1, a sulfide-based solid electrolyte film including a sulfide-based solid electrolyte and a fibrous binder is shown as an example, but the present disclosure is not limited thereto.

The method for analyzing a solid electrolyte film structure according to an embodiment of the present disclosure includes a immersion step of dissolving a solid electrolyte in a solid electrolyte film comprising the solid electrolyte and a binder with a polar solvent. The immersion step allows for the removal of large chunks of the solid electrolyte that have penetrated into the solid electrolyte film structure. The polar solvent selectively dissolves only the solid electrolyte, but not the binder. According to an embodiment of the present disclosure, the polar solvent may comprise at least one selected from a group consisting of water and alcohol. According to an embodiment of the present disclosure, the alcohol is an alcohol with a carbon number of 4 or less. If the carbon number is too high, the polarity may decrease, reducing its effectiveness as a solvent. Considering the functionality as a solvent and processability of alcohols, ethanol can be desirably utilized.

According to an embodiment of the present disclosure, in the immersion step, the polar solvent is supplied such that the concentration of the solid electrolyte is 10 weight % or less, 5 weight % or less, 3 weight % or less, or 1 weight % or less. If the concentration of the solid electrolyte in the polar solvent becomes too high, the solubility of the polar solvent may be reduced and the solid electrolyte may not be effectively removed or additional removal processes may be required. Due to the high content of the solid electrolyte in the solid electrolyte film, the removal process can easily be performed in a single step.

In the above process, the immersion time may be from 5 minutes to 1 hour. If it is less than 5 minutes, the solid electrolyte may remain in the solid electrolyte film, and if it is greater than 1 hour, the process may be less efficient. Specifically, the immersion time may be 5 minutes or more, 8 minutes or more, or 10 minutes or more, and may be 1 hour or less, 50 minutes or less, or 40 minutes or less. A single immersion step may be sufficient for removal of the solid electrolyte. However, in other instances, multiple immersion steps may be employed for removal of the solid electrolyte.

The solid electrolyte may be any solid electrolyte commonly used in the technical field that is soluble in the solvent according to an embodiment of the present disclosure. According to an embodiment of the present disclosure, the solid electrolyte comprises an inorganic solid electrolyte, wherein the inorganic solid electrolyte is a sulfide-based solid electrolyte, a halide-based solid electrolyte, an oxide-based solid electrolyte, or a combination thereof.

The sulfide-based solid electrolyte includes sulfur atoms among the electrolyte components, but is not limited to any particular component, and may include one or more of crystalline solid electrolytes, amorphous solid electrolytes (glassy solid electrolytes), and glass-ceramic solid electrolytes.

The sulfide-based solid electrolyte may be one represented by Formula 1 below:

Lₐ₁M_{b1}P_{c1}S_{d1}Aₑ₁ <Formula 1>

In Formula 1 above, L is an element selected from Li, Na and K; M is an element selected from B, Zn, Sn, Si, Cu, Ga, Sb, Al and Ge; A represents I, Br, Cl, or F; and a1-e1 represent the composition ratio of each element, and a1:b1:c1:d1:e1 is 1˜12:0˜1:1:2˜12:0˜5.

For example, the sulfide-based solid electrolyte may be LPS-type sulfide containing sulfur and phosphorus, LPSCl-type sulfide, Li₄₋ₓGe₁₋ₓPₓS₄ (x is from 0.1 to 2, specifically, x is ¾, ⅔), Li_{10±1}MP₂X₁₂(M=Ge, Si, Sn, Al, X=S, Se), Li_{3.833}Sn_{0.833}As_{0.166}S₄, Li₄SnS₄, Li_{3.25}Ge_{0.25}P_{0.75}S₄, Li₂S—P₂S₅, B₂S₃—Li₂S, xLi₂S-(100-x)P₂S₅ (x is from 70 to 80), Li₂S—LiI—P₂S₅, Li₂S—LiI—Li₂O—P₂S₅, Li₂S—LiBr—P₂S₅, Li₂S—LiCl—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₂S—SiS₂—Li₃N, Li₂S—SiS₂—LiI, or Li₂S—B₂S₃—LiI, although not limited thereto. For example, the above LPSCl-type sulfide may be Li₆PS₅Cl.

The halide-based solid electrolyte may be one represented by Formula 2 below:

Li₆₋₃ₐMₐBr_{b}Cl_{c} <Formula 2>

In Formula 2 above, M is a metal other than Li, a is 0<a<2, b is 0≤b≤6, c is 0≤c≤6, and b+c=6.

For example, the halide-based solid electrolyte may include, but is not necessarily limited to, at least one of Li₃YCl₆ and Li₃YBr₆.

The oxide-based solid electrolyte may be that represented by the following Formula 3:

Li_{1+x+y}AlₓTi₂₋ₓSi_{y}P_{3-y}O₁₂ [Formula 3]

(In Formula 3 above, x is 0≤x≤2 and y is 0≤y≤3.)

For example, the above oxide-based solid electrolyte can be suitably selected from LLT-based with a perovskite structure such as Li₃ₓLa_{2/3-x}TiO₃, LISICON such as Li₁₄Zn(GeO₄)₄, LATP-based such as Li_{1.3}Al_{0.3}Ti_{1.7}(PO₄)₃, LAGP-based such as (Li₁₊ₓGe₂₋ₓAlₓ(PO₄)₃), phosphate-based such as LiPON, and the like for use, but is not necessarily limited thereto.

The method for analyzing the solid electrolyte film structure according to an embodiment of the present disclosure can be applied to any solid electrolyte film, provided that the solid electrolyte can be dissolved in a solvent. However, in the wet solid electrolyte film fabrication method in which the solid electrolyte is dissolved in a non-polar solvent with a conductive material and a binder and applied to form a solid electrolyte film structure, the solid electrolyte acts as a support within the solid electrolyte film. Thus, applying the corresponding solid electrolyte film structure analysis method to the solid electrolyte film structure may cause collapse due to dissolution of the solid electrolyte. Therefore, the analysis method for the solid electrolyte film structure can be applied effectively to the solid electrolyte film structure that is fabricated in a dry state by introducing a solid electrolyte into the binder, and the solid electrolyte film structure is sufficiently supported solely by the binder.

Further, the binder may be a fibrous binder and/or a particulate binder. The fibrous binder may be incorporated into a solid electrolyte fabricated by physically mixing the binder with the solid electrolyte during a dry process. During the dry process, the binder may be fibrillized by physically mixing to become a fibrous binder.

The binders may include one or more selected from polytetrafluoroethylene (PTFE), ethylene-vinyl acetate (EVA), styrene-ethylene-butylene-styrene (SEBS), styrene butadiene rubber (SBR), nitrile butadiene rubber (NBR), and hydrogenated nitrile butadiene rubber (HNBR).

Hereinafter, exemplary embodiments are presented to facilitate the understanding of the present disclosure, but the following embodiments are provided to facilitate the understanding of the present disclosure, and the present disclosure is not limited to the embodiments. It is apparent to those skilled in the art that various changes and modifications can be made within the scope and spirit of the invention as set forth in the appended claims.

TABLE 1

| | | | Weight Ratio | | | |
|---|---|---|---|---|---|---|
| | Solid | | (solid | | Concentration | Time |
| | electrolyte | Binders | electrolyte:binder) | Solvent | (weight %) | (min) |
| Example 1 | Li₆PS₅Cl | SEBS | 97:3 | Water | 1 | 10 |
| Example 2 | Li₆PS₅Cl | SEBS | 97:3 | Ethanol | 1 | 10 |
| Example 3 | Li₆PS₅Cl | SEBS | 97:3 | Water | 3 | 20 |
| Example 4 | Li₆PS₅Cl | SEBS | 97:3 | Water | 1 | 30 |
| Example 5 | Li₆PS₅Cl | SEBS | 98:2 | Water | 1 | 10 |
| Example 6 | Li₆PS₅Cl | EVA | 97:3 | Water | 1 | 10 |
| Example 7 | Li₆PS₅Cl | PTFE | 99.5:0.5 | Water | 1 | 10 |
| Example 8 | Li₆PS₅Cl | SEBS | 97:3 | Water | 3 | 1 |
| Comparative | Li₆PS₅Cl | SEBS | 97:3 | — | — | — |
| Example 1 | | | | | | |
| Comparative | Li₆PS₅Cl | PTFE | 99.5:0.5 | — | — | — |
| Example 2 | | | | | | |

### EXAMPLES

### Example 1

### 1-1. Fabrication of a Solid Electrolyte Film

Styrene-ethylene-butylene-styrene (SEBS) particles (Sigma Aldrich, 200557), which is a binder, were dissolved in xylene solvent at 2 weight %, and Li₆PS₅Cl powder, which is a sulfide-based solid electrolyte, was further mixed to fabricate a uniform slurry. The slurry was then coated on a PET release film, dried, and calendared five times with a roll press to produce a solid electrolyte film with a thickness of about 50 μm. The content of the binder in the fabricated solid electrolyte film was 3 weight %.

### 1-2. Analysis of Solid Electrolyte Film Structure

The solid electrolyte film was fixed, and the solid electrolyte in the solid electrolyte film was immersed for 10 minutes in a water solvent such that the concentration of the solid electrolyte was 1 weight %. The water solvent was removed from the solid electrolyte film and dried, and the structure of the solid electrolyte film obtained was analyzed (FIG. 2).

### Example 2

The same method was used as in Example 1, except that ethanol solvent was used instead of water solvent.

### Example 3

The same method was used as in Example 1, except that the water solvent was immersed so that the concentration of the solid electrolyte was 3 weight %, and the immersion time was 20 minutes.

### Example 4

The same method was used as in Example 1, except that the immersion time was 30 minutes.

### Example 5

The same method was used as in Example 1, except for the content of the binder being 2 weight % in the solid electrolyte film.

### Example 6

The same method was used as in Example 1, except for using EVA (ethylene-vinyl acetate, Sigma Aldrich, 340502) particles instead of SEBS particles as the binder.

### Example 7

A mixture obtained by mixing PTFE (polytetrafluoroethylene) particles (Chemours) as a binder with Li₆PS₅Cl powder, a sulfide-based solid electrolyte, was calendared five times using a roll press to fabricate a solid electrolyte film with a thickness of 300 μm. The content of the binder in the fabricated solid electrolyte film was set to 0.5 weight %.

### Example 8

The same method was used as in Example 3, except for conducting a solvent treatment for 1 minute on the manufactured solid electrolyte film.

### Comparative Example 1

The solid electrolyte film fabricated in Example 1 was prepared without solvent treatment.

### Comparative Example 2

The solid electrolyte film fabricated in Example 7 was prepared without solvent treatment.

### Experimental Example 1: Analysis of Solid Electrolyte Film Structure

The structure of the solid electrolyte films obtained from the Examples and Comparative Examples were analyzed using SEM (Thermo Scientific, FEI Apreo SEM).

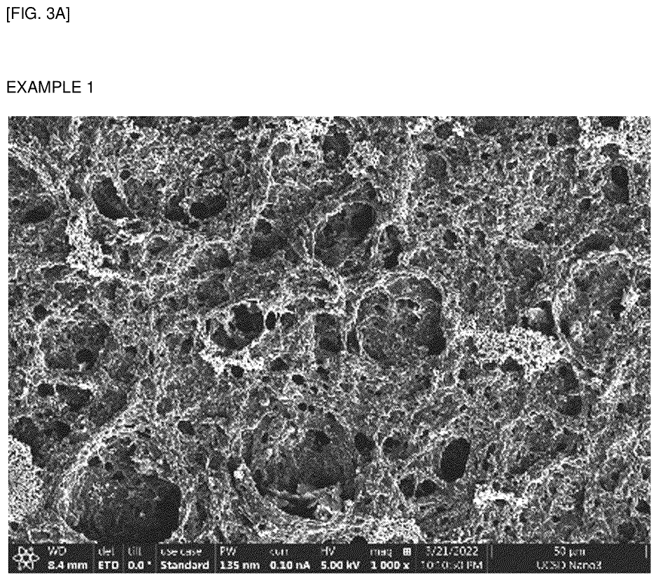

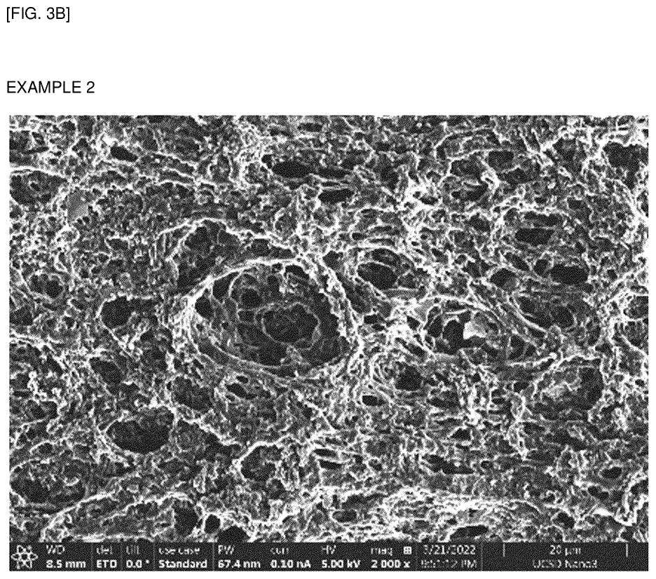

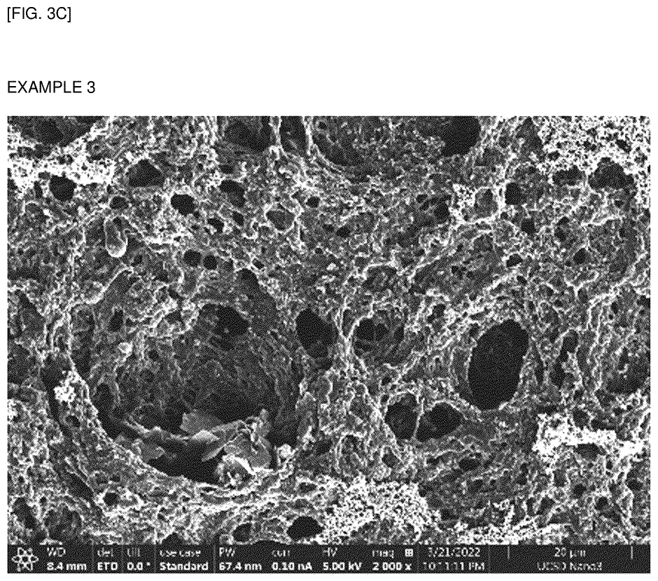

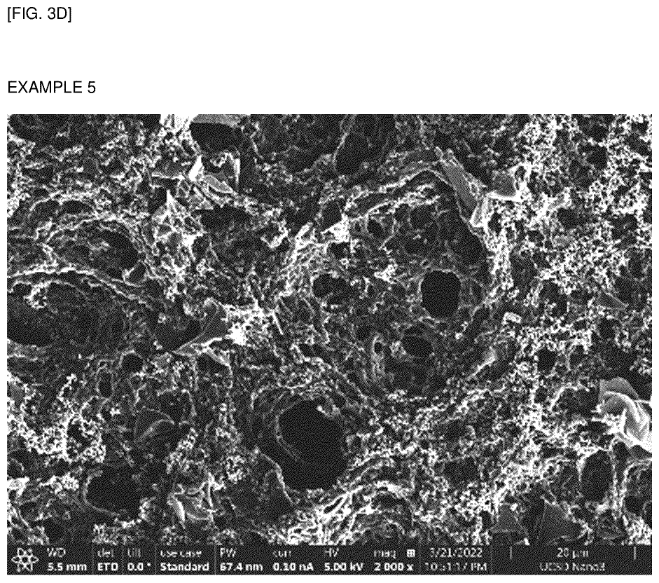

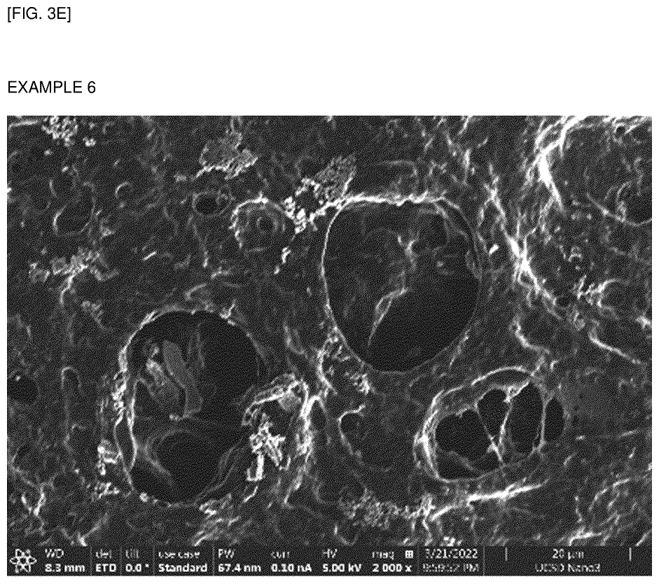

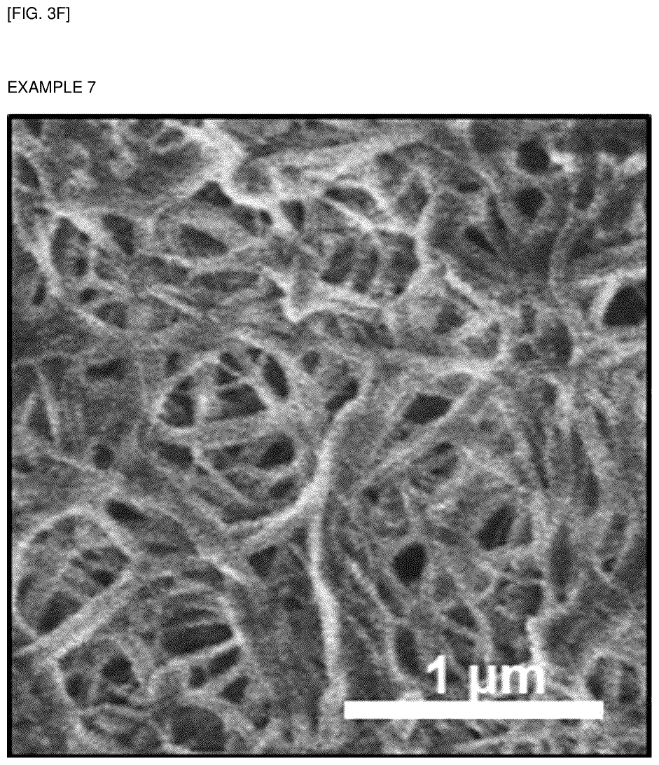

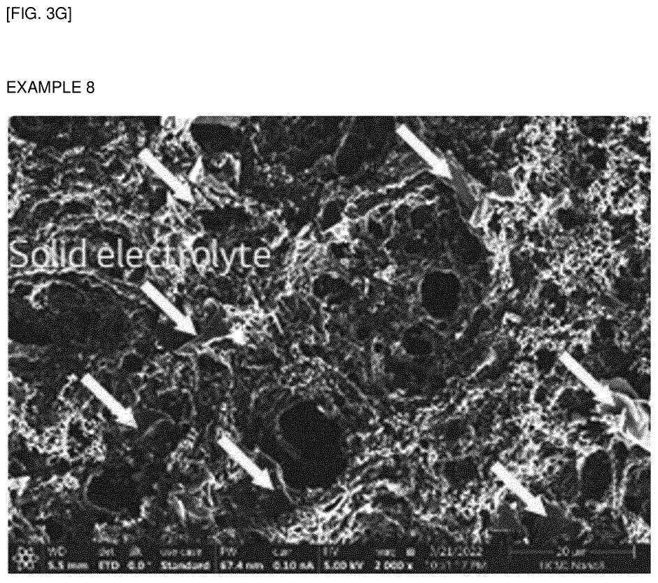

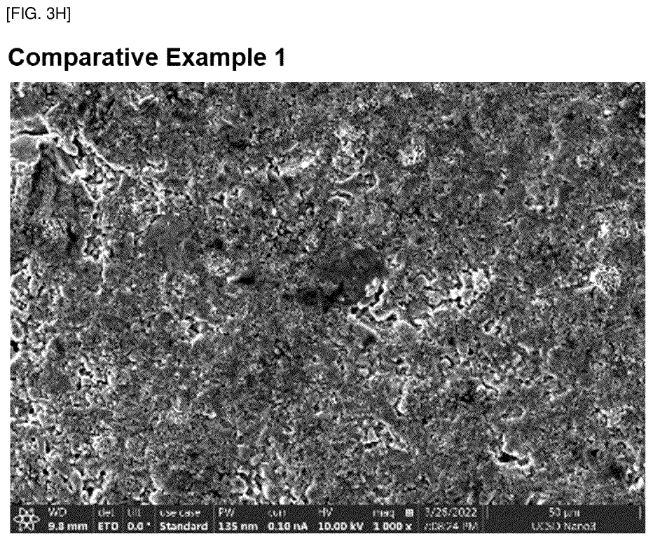

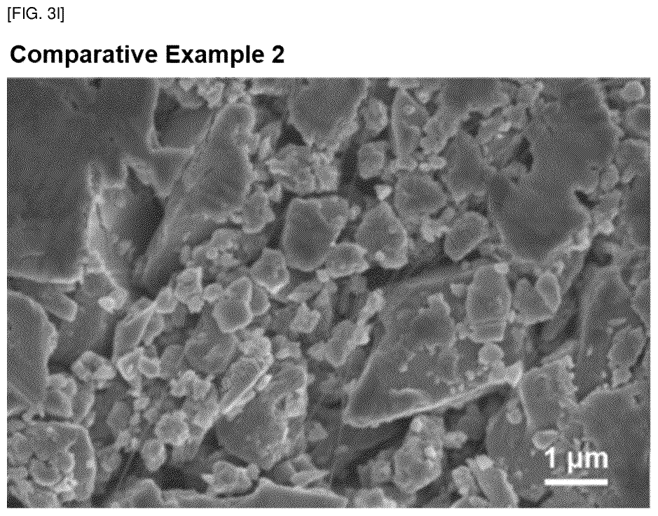

FIGS. 3A through 3I are SEM images of solid electrolyte films obtained from the Examples and Comparative Examples.

Referring to FIGS. 3A through 3I, it can be seen that in the solid electrolyte film of the Examples, only the binder frame was clearly visible after the solid electrolyte was removed. In particular, it can be seen that regardless of the structure of the binder and the fabrication method for the solid electrolyte film, the solid electrolyte contained in the solid electrolyte film was removed using water or ethanol. However, in Example 8, where the immersion time was relatively short, it can be seen that some solid electrolyte remain.

On the other hand, it can be seen that for the solid electrolyte film of the Comparative Examples, the solid electrolyte dissolution (immersion step) is not performed, making it difficult to identify the binder structure.

Although the present disclosure has been described with reference to limited embodiments and drawings, it should not be construed as being limited thereto. The present disclosure can undergo various modifications and variations within the technical spirit of the present disclosure and the equivalent scope of the claims listed below by those skilled in the technical field to which the present disclosure pertains.

What is claimed is:

1. A method for analyzing a solid electrolyte film structure, comprising the step of:
immersing a solid electrolyte film comprising a solid electrolyte and a binder into a polar solvent to remove the solid electrolyte from the solid electrolyte film; and
analyzing a structure of the solid electrolyte film in which the solid electrolyte is removed.

2. The method for analyzing a solid electrolyte film structure according to claim 1, wherein the polar solvent comprises at least one of water or alcohol.

3. The method for analyzing a solid electrolyte film structure according to claim 2, wherein the alcohol is an alcohol with a carbon number of 4 or less.

4. The method for analyzing a solid electrolyte film structure according to claim 3, wherein the alcohol is ethanol.

5. The method for analyzing a solid electrolyte film structure according to claim 1, wherein the solid electrolyte comprises at least one of a sulfide-based solid electrolyte, a halide-based solid electrolyte or an oxide-based solid electrolyte.

6. The method for analyzing a solid electrolyte film structure according to claim 5, wherein the sulfide-based solid electrolyte is represented by Formula 1:
Lₐ₁M_{b1}P_{c1}S_{d1}Aₑ₁ <Formula 1>
wherein in Formula 1, L is an element selected from Li, Na, and K; M is an element selected from B, Zn, Sn, Si, Cu, Ga, Sb, Al, and Ge; A is an element selected from I, Br, Cl, and F; each of a1, b1, c1, d1 and e1 represents a compositional ratio of each element; and a ratio of a1:b1:c1:d1:e1 is 1 to 12:0 to 1:1:2 to 12:0 to 5.

7. The method for analyzing a solid electrolyte film structure according to claim 5, wherein the sulfide-based solid electrolyte is LPS-type sulfide containing sulfur and phosphorus, LPSCl-type sulfide, Li₄₋ₓGe₁₋ₓPₓS₄ (x is from 0.1 to 2), Li_{10±1}MP₂X₁₂ (M=Ge, Si, Sn or Al, and X=S or Se), Li_{3.833}Sn_{0.833}As_{0.166}S₄, Li₄SnS₄, Li_{3.25}Ge_{0.25}P_{0.75}S₄, Li₂S—P₂S₅, B₂S₃—Li₂S, xLi₂S-(100-x)P₂S₅ (x is from 70 to 80), Li₂S—LiI—P₂S₅, Li₂S—LiI—Li₂O—P₂S₅, Li₂S—LiBr—P₂S₅, Li₂S—LiCl—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₂S—SiS₂—Li₃N, Li₂S—SiS₂—LiI, or Li₂S—B₂S₃—LiI.

8. The method for analyzing a solid electrolyte film structure according to claim 5, wherein the halide-based solid electrolyte is represented by Formula 2:
Li₆₋₃ₐMₐBr_{b}Cl_{c} <Formula 2>
wherein in Formula 2, M is a metal other than Li, a is 0<a<2, b is 0≤b≤6, c is 0≤c≤6, and b+c=6.

9. The method for analyzing a solid electrolyte film structure according to claim 5, wherein the oxide-based solid electrolyte is represented by Formula 3:
Li_{1+x+y}AlₓTi₂₋ₓSi_{y}P_{3-y}O₁₂ <Formula 3>
wherein in Formula 3, x is 0≤x≤2 and y is 0≤y≤3.

10. The method for analyzing a solid electrolyte film structure according to claim 5, wherein the oxide-based solid electrolyte is LLT-based solid electrolyte with a perovskite structure, LISICON, LATP-based solid electrolyte, LAGP-based solid electrolyte, or phosphate-based solid electrolyte.

11. The method for analyzing a solid electrolyte film structure according to claim 1, wherein the binder comprises a fibrous binder or a particulate binder.

12. The method for analyzing a solid electrolyte film structure according to claim 1, wherein the binder comprises at least one selected from the group consisting of:
polytetrafluoroethylene (PTFE), ethylene-vinyl acetate (EVA), styrene-ethylene-butylene-styrene (SEBS), styrene butadiene rubber (SBR), nitrile butadiene rubber (NBR) and hydrogenated nitrile butadiene rubber (HNBR).

13. The method for analyzing a solid electrolyte film structure according to claim 1, wherein the polar solvent in the immersion step is supplied to achieve a concentration of the solid electrolyte to 10 weight % or less.

14. The method for analyzing a solid electrolyte film structure according to claim 1, wherein the immersion step is performed for a period of 5 minutes to 1 hour.

15. The method for analyzing a solid electrolyte film structure according to claim 14, wherein the immersion step is performed for a period of 10 minutes to 1 hour.

16. The method for analyzing a solid electrolyte film structure according to claim 1, wherein the analyzing step comprises analyzing a frame formed by the binder after removal of the solid electrolyte from the solid electrolyte film comprising the solid electrolyte and the binder.

17. The method for analyzing a solid electrolyte film structure according to claim 1, wherein the polar solvent selectively dissolves only the solid electrolyte, but not the binder.

18. The method for analyzing a solid electrolyte film structure according to claim 1, wherein the analyzing step is performed utilizing a Scanning Electron Microscope (SEM) image of the solid electrolyte film in which the solid electrolyte is removed.

19. The method for analyzing a solid electrolyte film structure according to claim 1, wherein the solid electrolyte film is fabricated by a dry process.

20. The method for analyzing a solid electrolyte film structure according to claim 1, wherein the binder comprises at least one of ethylene-vinyl acetate (EVA) or styrene-ethylene-butylene-styrene (SEBS), and
wherein the polar solvent comprises at least one of water or ethanol.
